(19) United States
(12) Patent Application Publication
(10) Pub. No.: US 2015/0085078 A1
(43) Pub. Date: Mar. 26, 2015

(54) Method and System for Use in Detecting Three-Dimensional Position Information of Input Device

(71) Applicant: Jeenon, LLC, Santa Clara, CA (US)

(72) Inventors: Dongge Li, Xi'an (CN); Wei Wang, Xi'an (CN)

(21) Appl. No.: 14/371,391

(22) PCT Filed: Jan. 9, 2013
(86) PCT No.: PCT/CN2013/070285

§ 371 Date: Dec. 1, 2014

(30) Foreign Application Priority Data
Jan. 9, 2012 (CN) 201210004658.0

(51) Int. Cl. H04N 13/02

(52) U.S. Cl. CPC H04N 13/0203
USPC 348/46

(57) ABSTRACT

An objective of the present invention is to provide a method and system of detecting three-dimensional position information of an input device. Herein, the input device comprises at least one light-emitting source; imaging information of the light-emitting source is captured by a camera; an input light spot of the light-emitting source is detected based on the imaging information; three-dimensional position information of the input device is obtained based on light spot attribute information of the input light spot by means of a predetermined mapping relationship. Compared with the prior art, the present invention can capture imaging information of a light-emitting source by only one camera to further obtain three-dimensional position information of an input device to which the light-emitting source belongs, thereby reducing hardware costs of the system as well as computational complexity.

### FIELD OF THE INVENTION

The present invention relates to the field of information technology, and more specifically, to a technique of detecting three-dimensional position information of an input device.

### BACKGROUND OF THE INVENTION

The existing three-dimensional position detection methods mainly comprise capturing imaging information of a light-emitting source through two cameras, and calculating three-dimensional position information of the light-emitting source based on a binocular stereo vision algorithm. Further, the binocular stereo vision algorithm can only calculate a three-dimensional translational position of the light-emitting source.

### SUMMARY OF THE INVENTION

An objective of the present invention is to provide a method and system of detecting three-dimensional position information of an input device.

According to one aspect of the present invention, a method of detecting three-dimensional position information of an input device is provided, wherein the input device comprises at least one light-emitting source;

wherein the method comprises steps of:
a. capturing by a camera imaging information of the light-emitting source;
b. detecting an input light spot of the light-emitting source based on the imaging information;
c. obtaining three-dimensional position information of the input device based on light spot attribute information of the input light spot by means of a predetermined mapping relationship.

Preferably, the three-dimensional position information comprises three-dimensional rotational position information of the input device.

According to one of the preferred embodiments of the present invention, the step c comprises: obtaining the three-dimensional position information of the input device based on the light spot attribute information of the input light spot by mean of a predetermined fitting curve.

Preferably, the three-dimensional position information of the input device comprises three-dimensional translational position information of the input device and the predetermined fitting curve comprises a predetermined distance fitting curve; wherein the step c comprises: determining distance information of the input device with respect to the camera based on the light spot attribute information of the input light spot by mean of the predetermined distance fitting curve; and obtaining the three-dimensional translational position information of the input device based on the distance information and two-dimension coordinate of the input light spot in the imaging information.

According to one of the preferred embodiments of the present invention, the step c comprises: obtaining the three-dimensional position information of the input device based on the light spot attribute information of the input light spot by means of looking up a predetermined light spot attribute sample table.

Preferably, the step c comprises: obtaining the three-dimensional position information of the input device based on the light spot attribute information of the input light spot by means of looking up the predetermined light spot attribute sample table and a sample interpolation algorithm.

Preferably, the three-dimensional position information of the input device comprises three-dimensional translational position information of the input device, and the predetermined light spot attribute sample table comprises a predetermined light spot attribute-distance sample table; wherein the step c comprises: determining distance information of the input device with respect to the camera based on the light spot attribute information of the input light spot by means of the predetermined light spot attribute-distance sample table; and obtaining the three-dimensional translational position information of the input device based on the distance information and two-dimensional coordinate of the input light spot in the imaging information.

More preferably, the step c further comprises: determining the distance information based on the light spot attribute information of the input light spot by means of the predetermined light spot attribute-distance sample table and the sample interpolation algorithm.

According to one of the preferred embodiments of the present invention, the imaging information comprises a plurality of frames of images of the light-emitting source; wherein the step c comprises: obtaining the three-dimensional position information of the input device based on the light spot attribute information of the input light spot by means of the predetermined mapping relationship and a multi-frame averaging algorithm.

Preferably, the step c comprises: obtaining average light spot attribute information based on the light spot attribute information of the input light spot in each of the plurality of frames of images by means of the multi-frame averaging algorithm; and obtaining the three-dimensional position information of the input device based on the average light spot attribute information by means of the predetermined mapping relationship.

Preferably, the step c comprises: obtaining reference three-dimensional position information of the input device corresponding to each of the plurality of frames of images based on the light spot attribute information of the input light spot in each of the plurality of frames of images by means of the predetermined mapping relationship; and obtaining the three-dimensional position information of the input device based on the reference three-dimensional position information by means of the multi-frame averaging algorithm.

According to one of the preferred embodiments of the present invention, the imaging information comprises at least two images of the light-emitting source in the same time, wherein each of the at least two images belongs to a different resolution level; wherein the step b comprises: obtaining a candidate area corresponding to the input light spot based on the image of a relatively lower resolution level in the at least two images; and obtaining the input light spot based on the candidate area of a higher resolution level in the at least two images.

According to one of the preferred embodiments of the present invention, the step a comprises: capturing by the camera to obtain a high-resolution image of the light-emitting source; and searching the input light spot in a low-resolution image obtained from the high-resolution image, to determine a to-be-detected area and a resolution thereof for further detecting the input light spot, the resolution of the to-be-detected area being higher than the resolution of the low-resolution image; and obtaining a second image corresponding to the to-be-detected area and the resolution thereof, and using the second image as the imaging information for the input light source.

Preferably, the to-be-detected area and the resolution thereof are determined based on at least one of the following information:
the size of the input light spot;
the distance of the input device;
the historical use state of the input device.

According to one of the preferred embodiments of the present invention, the step a comprises: capturing by the camera to obtain a low-resolution image of the light-emitting source; and determining a to-be-detected area of the input light spot from the low-resolution image based on imaging information of prior frame(s) of the light-emitting source in combination with motion feature information of the input device; and using a high-resolution image corresponding to the to-be-detected area as the imaging information for the input light source.

According to one of the preferred embodiments of the present invention, the step b comprises: obtaining a plurality of candidate light spots based on the imaging information; and filtering to determine the input light spot from the plurality of candidate light spots based on a light emitting mode of the light-emitting source.

Preferably, the light spot attribute information of the input light spot corresponding to the light emitting mode of the light-emitting source comprises color distribution pattern of the light spot and size of the light spot; the filtering operation in the step b comprises: determining the candidate light spot as the input light spot when the color distribution pattern of the candidate light spot is of a looped structure, and the color distribution pattern of the candidate light spot matches the size thereof.

According to one of the preferred embodiments of the present invention, the input device comprises a plurality of light-emitting sources; the step b comprises: obtaining an input light spot group corresponding to the plurality of light-emitting sources based on the imaging information, wherein each input light spot in the input light spot group corresponds to one of the plurality of light-emitting sources, and detecting one or more input light spots in the input light spot group so as to be used for obtaining three-dimensional position information of one or more of the plurality of light-emitting sources; the step c further comprises: obtaining the three-dimensional position information of the one or more of the plurality of light-emitting sources based on the light spot attribute information of the one or more input light spots by means of the predetermined mapping relationship, and determining the three-dimensional position information of the input device based on the three-dimensional position information of the one or more of the plurality of light-emitting sources.

Preferably, the plurality of light-emitting sources are configured according to predetermined rule(s), the predetermined rule(s) comprises at least one of the following items:
configuring the plurality of light-emitting sources according to different optical features;
configuring the plurality of light-emitting sources according to different light emitting modes;
configuring the plurality of light-emitting sources according to a predetermined geometrical structure.

According to another aspect of the present invention, a system of detecting three-dimensional position information for an input device is provided, wherein the system comprises an input device and a detection device, the input device comprising at least one light-emitting source, the detection device comprising a camera and at least one processing module;

the camera being for capturing imaging information of the light-emitting source; wherein the processing module is configured to:
detect an input light spot of the light-emitting source based on the imaging information;
obtain three-dimensional position information of the input device based on light spot attribute information of the input light spot by means of a predetermined mapping relationship.

According to one of the preferred embodiments of the present invention, the input device comprises a plurality of light-emitting sources; the operation of detecting input light spots of the light-emitting sources comprises:
obtaining an input light spot group corresponding to the plurality of light-emitting sources based on the imaging information, wherein each input light spot in the input light spot group corresponds to one of the plurality of light-emitting sources;
detecting one or more input light spots in the input light spot group so as to be used for obtaining three-dimensional position information of one or more of the plurality of light-emitting sources; wherein the processing module is further configured to
determine the three-dimensional position information of the input device based on the three-dimensional position information of the one or more of the plurality of light-emitting sources.

Compared with the prior art, the present invention can capture imaging information of a light-emitting source by only one camera to further obtain three-dimensional position information of an input device to which the light-emitting source belongs, thereby reducing hardware costs of the system as well as computational complexity.

Further, the present invention can not only obtain three-dimensional translational position information of an input device, but also obtain three-dimensional rotational position information of the input device, thereby improving the accuracy and sensibility of detecting three-dimensional positions of the input device.

### BRIEF DESCRIPTION OF THE SEVERAL VIEWS OF THE DRAWINGS

The other features, objectives and advantages of the present invention will become more apparent through detailed depictions on the non-limiting embodiments with reference to the following

### DRAWINGS

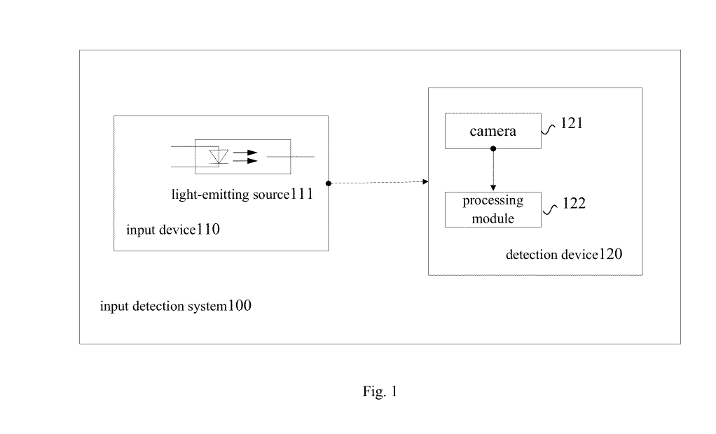

FIG. 1 illustrates a diagram of a system of detecting three-dimensional position information of an input device according to one aspect of the present invention;

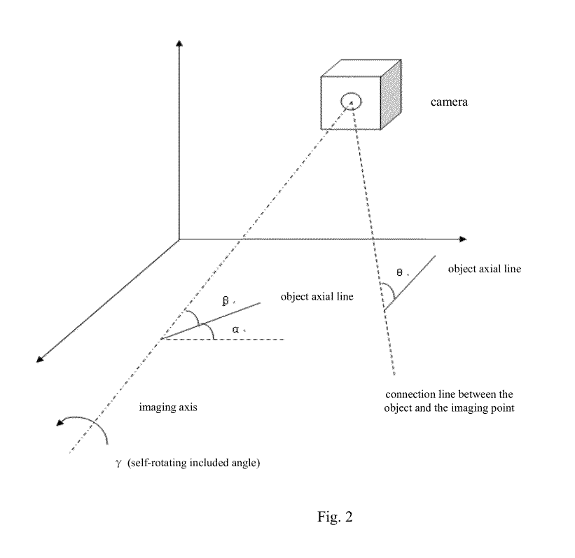

FIG. 2 illustrates a diagram of indicating three-dimensional rotational position information of an input device according to the present invention;

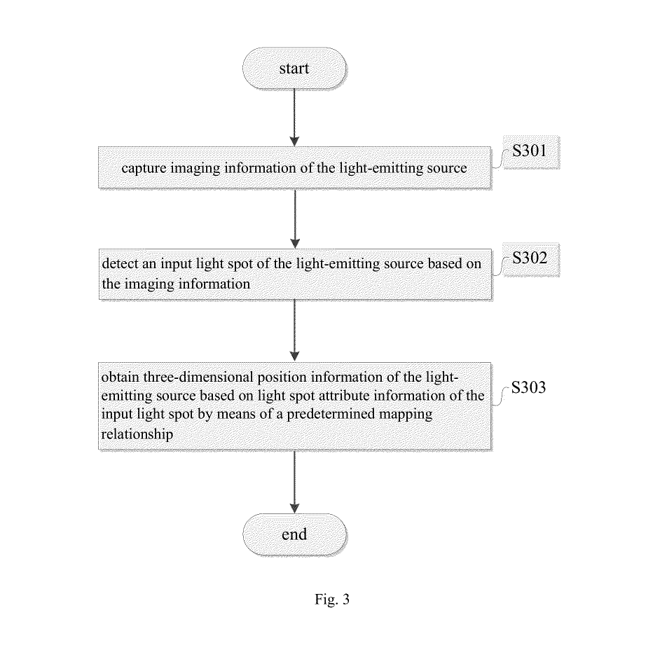

FIG. 3 illustrates a flowchart of a method of detecting three-dimensional position information of an input device according to another aspect of the present invention;

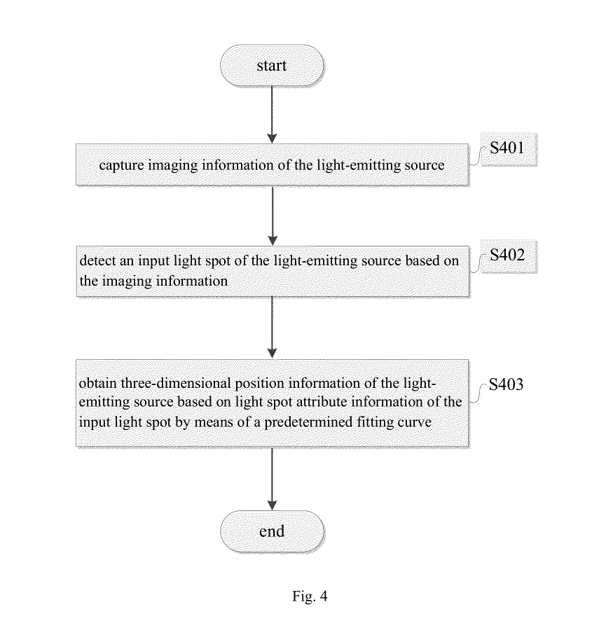

FIG. 4 illustrates a flowchart of a method of detecting three-dimensional position information of an input device according to a preferred embodiment of the present invention;

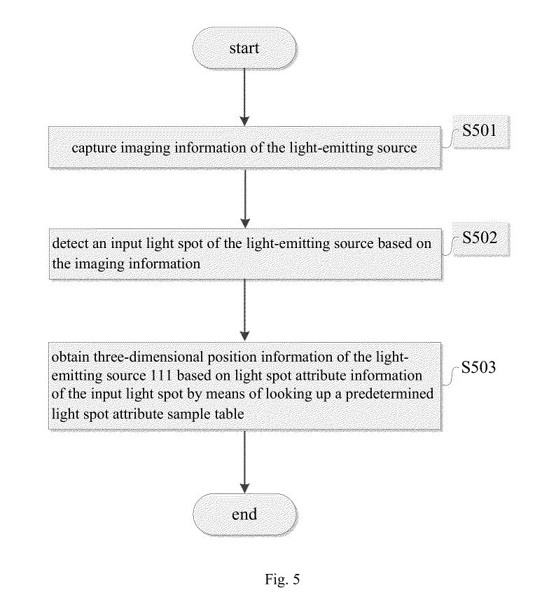

FIG. 5 illustrates a flowchart of a method of detecting three-dimensional position information of an input device according to another preferred embodiment of the present invention;

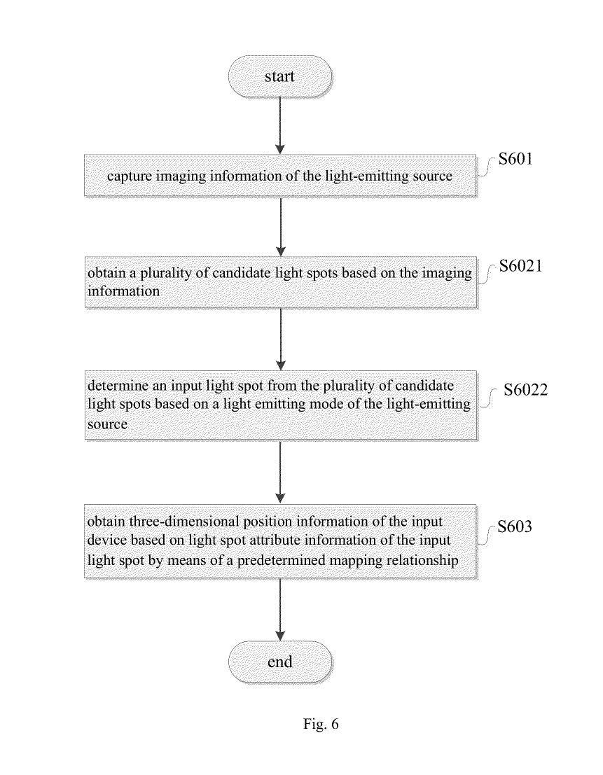

FIG. 6 illustrates a flowchart of a method of detecting three-dimensional position information of an input device according to a further preferred embodiment of the present invention;

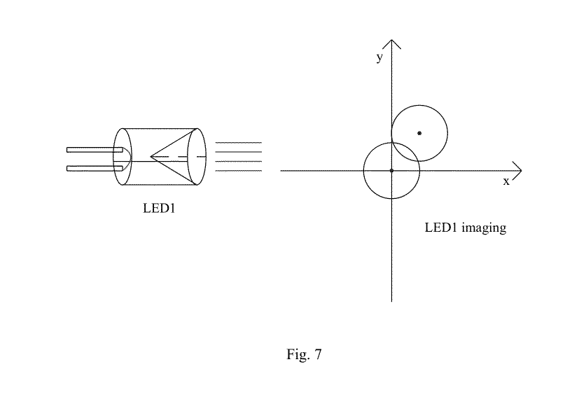

FIG. 7 illustrates an example of an imaging of an LED light source according to the present invention;

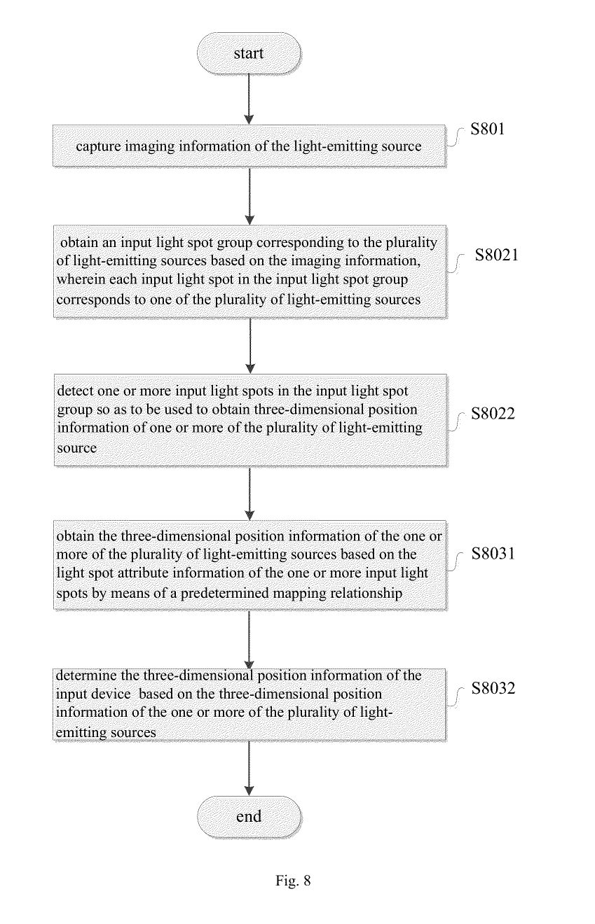

FIG. 8 illustrates a flowchart of a method of detecting three-dimensional position information of an input device according to a still further embodiment of the present invention;

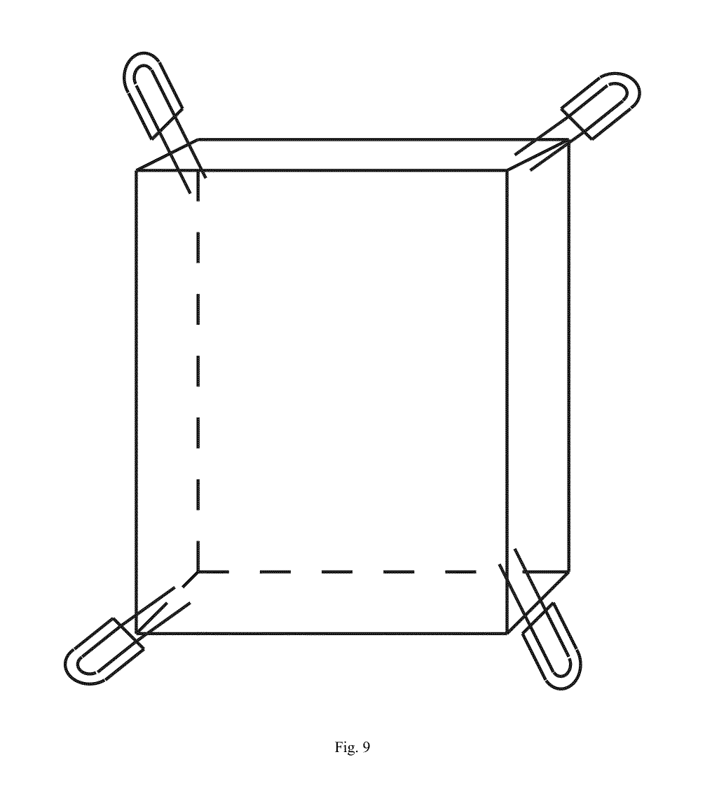

FIG. 9 illustrates a diagram of an arrangement pattern of an input device comprising 4 LED light sources according to the present invention;

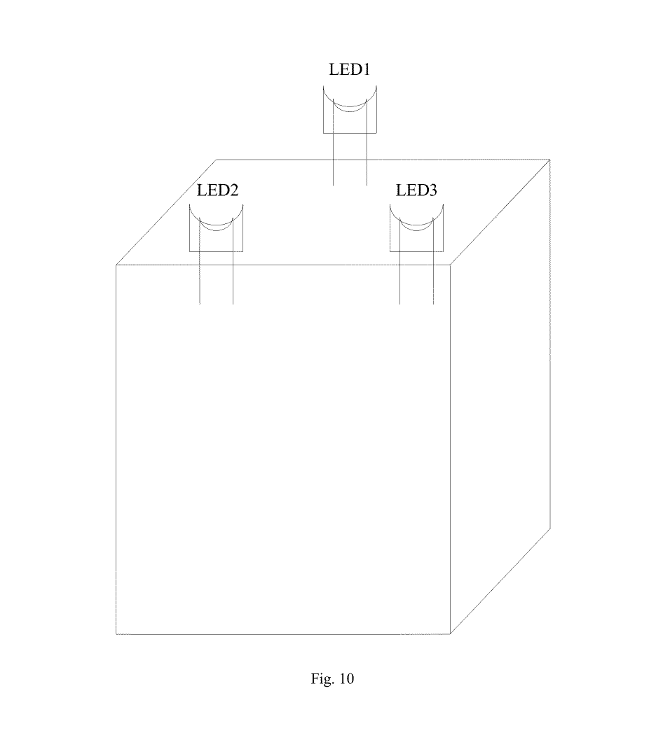

FIG. 10 illustrates a diagram of an arrangement pattern of an input device comprising 3 LED light sources according to the present invention;

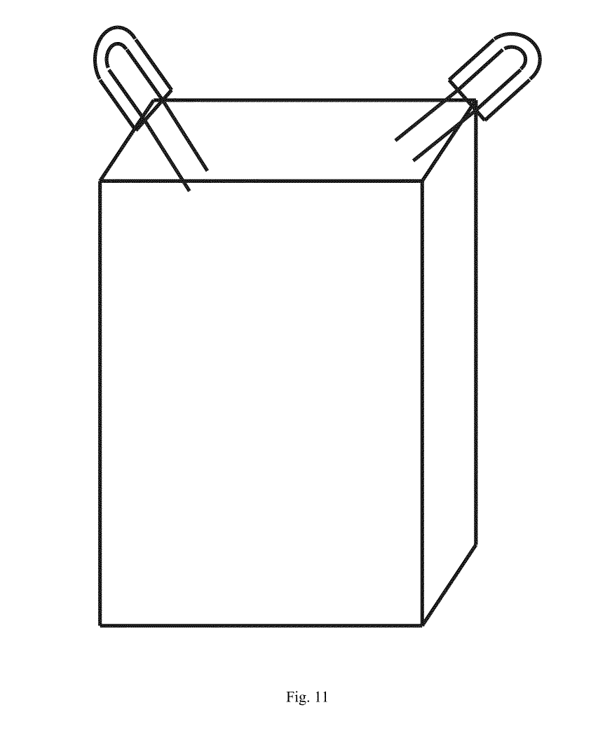

FIG. 11 illustrates a diagram of an arrangement pattern of an input device comprising 2 LED light sources according to the present invention;

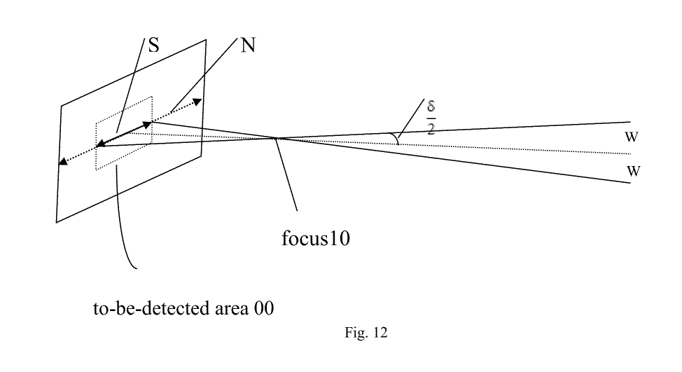

FIG. 12 illustrates a diagram of determining a to-be-detected area in the imaging information of a light-emitting source according to one preferred embodiment of the present invention;

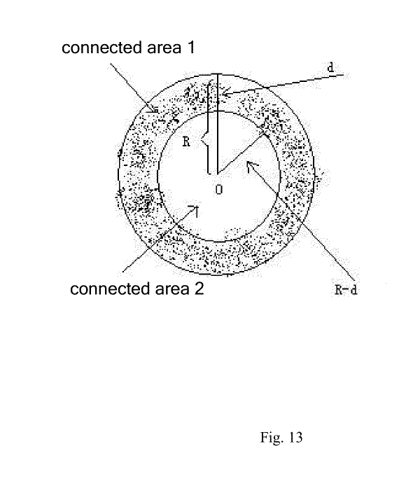

FIG. 13 illustrates a diagram of a color distribution pattern of a candidate light spot according to one preferred embodiment of the present invention.

Same or like reference numerals in the accompanying drawings represent the same or like components.

### DETAILED DESCRIPTION OF THE INVENTION

Hereinafter, the present invention will be described further in detail with reference to the accompanying drawings.

FIG. 1 illustrates a diagram of a system according to one aspect of the present invention, which illustrates an input detection system for detecting three-dimensional position information of an input device.

As illustrated in FIG. 1, an input detection system 100 comprises an input device 110 and a detection device 120, wherein the input device 110 and the detection device 120 are disposed at two ends, respectively. The input device 110 comprises at least one light-emitting source 111. The detection device 120 comprises at least one processing module 122, and at least a camera 121 is built in or externally connected to the detection device 120.

The camera 121 captures imaging information of the light-emitting source 111; the processing module 122 detects an input light spot of the light-emitting source 111 based on the imaging information and obtains three-dimensional position information of the light-emitting source 111 based on light spot attribute information of the input light spot in accordance with a predetermined mapping relationship.

In the present invention, since the light-emitting source 111 is mounted to the input device 110, the three-dimensional position information and motion features and the like of the input device 110 can be represented by the three-dimensional position information and the motion features and the like of the light-emitting source 111, and the two are used equivalently. Further, when the input device 110 comprises one light-emitting sources 111, the three-dimensional position information of the input device 110 may be directly represented by the three-dimensional position information of the light-emitting source 111; when the input device 110 comprises a plurality of light-emitting sources 111, the three-dimensional position information of the input device 110 may be directly represented by the three-dimensional position information of one of the light-emitting sources 111, or the three-dimensional position information of the input device 110 may be determined through relevant calculation on the three-dimensional position information of one or more light-emitting sources 111 thereof.

For example, the camera 121 shoots an image of the light-emitting source 111; the processing module 122 selects a round light spot from the image as the input light spot of the light-emitting source 111. For example, the processing module 122 performs binarization processing on the image according to a preset threshold, in order to facilitate detecting the round light spot, then detects the round light spot through Hough transformation and calculates circle radius and circle center coordinate. Only a round light spot whose radius falls within a predetermined valid radius range is counted as a valid round light spot. If there is a plurality of eligible round light spots, the brightest round light spot may be selected as the input light spot. The processing module 122 looks up a preset light spot attribute-distance sample table to obtain distance information of the light-emitting source 111 with respect to the camera 121, based on the circle radius and brightness of the input light spot, and then calculates in combination with the two-dimensional coordinate of the circle center of the input light spot in the image to obtain the three-dimensional translational position information of the light-emitting source 111.

Here, the light spot attribute information of the input light spot, which corresponds to the light emission pattern of the light-emitting source 111, includes, but not limited to, any relevant optical attributes which are applicable to the present invention and may be directly or indirectly used to determine the three-dimensional position information of the light-emitting source 111. The light spot attribute information of the input light spot may comprise at least one item of the following:

1) the shape of the input light spot, for example, a corresponding input light spot is round or oval due to the shape or disposing angle of the LED light source;
2) the size of the input light spot, which may be characterized by circle radius, area, etc.;
3) the brightness of the input light spot;
4) the light distribution feature of the input light spot, for example, the light distribution of the input light will vary monotonically with three-dimensional rotational position information of the light-emitting source 111;
5) the dimming distribution pattern of the input light spot, for example, .the center of the LED light source does not emit light, then the corresponding input light spot is a round light spot with a dark spot at the center.
6) the color distribution pattern of the input light spot, for example, the light-emitting source 111 is a color LED, then the color distribution pattern of the corresponding input light spot is of a loop structure.

The three-dimensional position information of the light-emitting source 111 includes, but not limited to, three-dimensional translational position information of the light-emitting source 111 and/or three-dimensional rotational position information of the light-emitting source 111.

Likewise, the three-dimensional position information of the input device 110 includes, but not limited to, three-dimensional translational position information of the input device 110 and/or three-dimensional rotational position information of the input device 110.

Here, the image center-based two-dimensional coordinate of the circle center of the input light spot in the image is denoted as (x, y), wherein x is the horizontal coordinate of the circle center of the input light spot in the image, while y is the vertical coordinate of the circle center of the input light spot in the image.

If the three-dimensional coordinate of a spatial origin is denoted as (X₀, Y₀, Z₀), then the three-dimensional translational position information of the light-emitting source 111 is three-dimensional coordinate (X, Y, Z), wherein X denotes the horizontal coordinate of the center of mass of the light-emitting source 111, Y denotes the vertical coordinate of the center of mass of the light-emitting source 111, and Z denotes the deep coordinate of the center of mass of the light-emitting source 111. Through the equation X=x(λ−Z)/λ, Y=y(λ−Z)/λ, the three-dimensional position information (X, Y, Z) of the light-emitting source 111 may be calculated from the two-dimensional coordinate (x, y) of circle center of the light-emitting source 111, wherein λ, denotes the focal distance of the camera; the specific calculation manner of the distance information Z of the light-emitting source 111 with respect to the camera 121 will be described in detail hereinafter.

As illustrated in FIG. 2, the three-dimensional rotational position information of the light-emitting source 111 may be denoted as θ, wherein θ denotes an included angle between the axial line of the light-emitting source 111 and the connection line from the light-emitting source 111 to the camera 112. Further, the three-dimensional rotational position information of the light-emitting source 111 may also be denoted as (θ, γ), wherein γ denotes a rotating angle of the light-emitting source 111 around its center of mass, i.e., the self-rotating included angle of the light-emitting source 111. Besides, according to the aforementioned included angle θ, with reference to the three-dimensional translational position information (X, Y, Z) of the light-emitting source 111, the three-dimensional rotational position information of the light-emitting source 111 may be further denoted as (α, β, γ), i.e., the spatial orientation of the light-emitting source 111 through its centroidal axis, wherein α denotes a horizontal direction included angle of the light-emitting source 111 through its centroidal axis, β denotes the vertical direction included angle of the light-emitting source 111 through its centroidal axis. When the input device 110 comprises a plurality of light-emitting sources 111, γ may be used to characterize more accurately a user's various operations to the input device 110; if the user rotates the input device 110, the self-rotating included angle γ of the input device 110 may be determined based on the deflection of the geometric structure formed by the plurality of light-emitting sources 111. Moreover, the included angle θ may be the included angle between the axial line of the input device 110 and the connection line from the input device 110 to the camera 122.

A predetermined mapping relationship includes, but not limited to, any mapping manner which are applicable to the present invention and to obtain the three-dimensional position information of the light-emitting source 111 by means of corresponding processing to the light spot attribute information of the input light spot, such as a fitting curve of the three-dimensional position information obtained based on the light spot attribute information, sample table of the light spot attribute information and the three-dimensional position information, etc.

Still referring to FIG. 1, the light-emitting source 111 includes, but not limited to, any light emitting object applicable to the present invention including various kinds of spot light source, surface light source, etc., such as LED light source, infrared light source, OLED light source, etc. For the sake of simplifying the description, in most cases, the present invention illustrated the light-emitting source 111 with the LED light source as an example. However, those skilled in the art should understand that such example is only for simply explaining the present invention, which should not be construed as any limitation to the present invention.

The camera 121 includes, but not limited to, any image acquisition device applicable to the present invention and capable of sensing and acquiring images of such as LED visible light, infrared light, etc. For example, the camera 121 has 1) high enough acquisition frame rate, e.g. 15 fps or above; 2) suitable resolution, e.g. 640*480 or above; 3) short enough exposure time, e.g. 1/500 or shorter.

The processing modules 122 includes, but not limited to, any electronic device applicable to the present invention and capable of automatically performing numerical value calculation and/or various kinds of information processing according to pre-stored code, and the hardware of which includes, but not limited to, a microprocessor, EPGA, DSP, embedded device, etc. Further, in the present invention, the detection device 120 may include one or more processing modules 122; when the processing module 122 is plural, each processing module 122 may be assigned a particular information processing operation so as to implement parallel calculation, thereby improving the detection efficiency.

Those skilled in the art should understand that the above light-emitting source 111, camera 121, and processing module 122 are only examples, and other existing or possibly evolved light-emitting source, camera or processing module in the future, if applicable to the present invention, should also be included within the protection scope of the present invention and is thus incorporated here by reference.

Further, in one preferred embodiment of the system, the input device 110 comprises a plurality of light-emitting sources 111. Herein the arrangement patterns of the plurality of LED light-emitting sources are respectively shown in FIG. 9, FIG. 10, and FIG. 11: FIG. 9 illustrates an arrangement pattern for 4 LED light-emitting sources; FIG. 10 illustrates an arrangement pattern for 3 LED light sources; and FIG. 11 illustrates an arrangement pattern for 2 LED light sources.

In the present invention, in the case of a plurality of light-emitting sources 111, the plurality of light-emitting sources 111 may be configured in accordance with predetermined rule(s), wherein the predetermined rule(s) includes, but not limited to, at least one of the following items:

1) configuring the plurality of light-emitting sources 111 according to different optical features;
2) configuring the plurality of light-emitting sources 111 according to different light emitting modes;
3) configuring the plurality of light-emitting sources 111 according to a predetermined geometrical structure.

Specifically, 1) the optical features include, but not limited to, any information which is applicable to the present invention and is used to characterize the optical related attributes of each light-emitting source 111, such as the wavelength, brightness, shape of the light-emitting source 111.

2) the light emitting mode includes, but not limited to, various light emitting performance of the light-emitting sources 111 which is applicable to the present invention, such as distribution of one or any combination of color, flickering frequency, brightness, and other attribute of the light emitted individually by the plurality of emitting light sources 111, adding reflecting material or light transparent material to the external of the light-emitting sources 111 to change the shape of corresponding input light spot, etc.
3) the geometric structure includes, but not limited to, any geometric structure applicable to the present invention and formed by more than two light-emitting sources 111 according to a certain distance and/or included angle, such as triangle, square, cube, etc.

Those skilled in the art should understand that the above predetermined rules for configuring a plurality of light-emitting sources are only exemplary, and other existing or possibly evolved predetermined rule of configuring a plurality of light-emitting sources in the future, if applicable to the present invention, should also be included within the protection scope of the present invention and is thus incorporated here by reference.

Here, the plurality of light-emitting sources 111 are configured by various kinds of rules, for example, each light-emitting source emits light of a different color or brightness, adopts a different flickering frequency, and is disposed according to a certain distance and angle, such that the detection device 120 may calculate and obtain the self-rotating angle γ of the input device 110 based on the change of relative position of each light-emitting source 111, thereby more accurately obtaining the three-dimensional rotational position information of the input device 110, which is significant to an application that requires accurate three-dimensional position information, for example, 3D game.

The camera 121 captures imaging information of the light-emitting sources 111; the processing module 122 obtains a group of input light spots corresponding to the plurality of light-emitting sources 111, wherein each input light spot in the group of input light spots corresponds to one of the plurality of light-emitting sources 111, and the processing module 122 detects one or more input light spots in the group of input light spots, which are to be available for obtaining three-dimensional position information of one or more of the plurality of light-emitting sources 111; the processing module 122 obtains the three-dimensional position information of the one or more of the plurality of light-emitting sources based on light spot attribute information of the one or more input light spots in accordance with a predetermined mapping relationship; the processing module 122 determines three-dimensional position information of the input device 110 based on the three-dimensional position information of the one or more of the plurality of light-emitting sources 111.

Here, the three-dimensional position information of the input device 110 may be determined at least from the following two dimensions:

1) first determining the input light spot(s) for calculation in the group of input light spots, and then determining the three-dimensional position information of the input device 110 based on the three-dimensional position information of the light-emitting source 111 corresponding to the input light spot(s), wherein the input light spot(s) for calculation may be all or some input light spots in the group of input light spots. The processing module 122 may select any input light spot in the group of input light spots as the input light spot for calculation and uses the three-dimensional position information of the light-emitting source 111 corresponding to the selected input light spot as the three-dimensional position information of the input device 110; or the processing module 122 may determine, based on the geometric structure of the selected input light spots for calculation, the three-dimensional position information of corresponding spots, so as to characterize the three-dimensional position information of the input device 110, for example, based on the gravity center of the geometry formed by the selected input light spots, the processing module 122 takes the three-dimensional position information of the gravity center as the three-dimensional position information of the input device 110.

For example, referring to FIG. 10, after the input light spots corresponding to the three LED light sources respectively are determined, the three-dimensional position information of the gravity center of the triangle formed by the three LED light sources is taken as the three-dimensional position information of the three LED light sources.

2) first obtaining the three-dimensional position information of each input light spot in the group of input light spots, and then determining the three-dimensional position information of the input device 110 by means of various calculation processing on the three-dimensional position information.

Here, the calculation processing includes, but not limited to, any of the various calculations applicable to the present invention on the three-dimensional position information of each input light spot in the group of the input light spots, such as averaging the three-dimensional position information of all input light spots, various calculations on the three-dimensional position information of a gravity center or apex based on the geometric structure between a plurality of LED light sources, etc.

FIG. 3 illustrates a flowchart of a method according to another aspect of the present invention, which illustrates a process of detecting three-dimensional position information of an input device, wherein the input device 110 comprises a light-emitting source 111, and the detection device 120 externally coupled to a camera 122.

With reference to FIGS. 1 and 3, in step S301, the camera 122 captures imaging information of the light-emitting source 111; in step S302, the detection device 120 detects an input light spot of the light-emitting source 111 based on the imaging information; in step S303, the detection device 120 obtains three-dimensional position information of the light-emitting source 111 based on light spot attribute information of the input light spot by means of a predetermined mapping relationship.

For example, in step S301, the camera 122 captures the imaging information of the light-emitting source 111; in the case of a high resolution image and a low resolution image at the same time for the light-emitting source 111, the high resolution image and the low resolution image may be shot at the same time, or only the high resolution image in shot, which is then sampled to obtain a corresponding low resolution image. In step S302, for a low resolution image of the light-emitting source 111, the detection device 120 detects a candidate area corresponding to the input light spot in the image, for example preliminarily detecting a small block of separate light spot or motion area in the low resolution image and performing further analysis only on the corresponding portion of the candidate area in the high resolution image; for example, detecting the high resolution image according to a shape, size, and the like of the light spot, and determining that the light spot with a round shape and a radius falling within a predetermined valid scope is the input light spot of the light-emitting source 111, wherein the motion area may be determined in combined with image(s) of the light-emitting source 111 at other time, by processing the low resolution image with differential method and then binarizing and thresholding the differentially processed low resolution image. In step S303, the detection device 120 obtains distance information Z of the light-emitting source 111 with respect to the camera 121 based on the circle radius r of the input light spot of the light-emitting source 111 by means of a calculation equation Z=c/r, wherein c is a constant related to parameters such as the camera focal distance and the size of the light-emitting source 111; and then the detection device 120 further calculates and obtains the three-dimensional translational position information (X, Y, Z) of the light-emitting source 111 through the equations X=x(λ−Z)/λ, Y=y(λ−Z)/λ, wherein λ, is the focal distance of the camera 121, in combination with the two-dimensional coordinate (x, y) of the circle center of the input light spot in the image.

Here, the light-emitting source 111 may select an LED light source with consistent light emitting features in each direction; for an LED light source with inconsistent light emitting features in each direction, its external may be covered with a light transparent ball, such that the LED light source may have consistent light emitting features in each direction through the light transparent ball, and the radius of corresponding input light spot is also consistent.

For another example, in step S301, the camera 122 shoots to obtain a high-resolution image of the light-emitting source 111, obtains a corresponding low-resolution image through sampling the high-resolution image, searches the input light spot of the light-emitting source 111 in the low-resolution image to determine a to-be-detected area and its resolution for further detecting the input light spot, which resolution being higher than the resolution of the above mentioned low-resolution image, obtains a second image corresponding to the to-be-detected area and its resolution, and provides the second image as the imaging information of the light-emitting source 111 to the detection device 120 such that the detection device 120 further detects in the imaging information the input light spot of the light-emitting source 111.

In order to reach a high positioning precision, the input detection system 100 may adopt a camera 121 with a higher resolution to capture an image. In particular, the further the distance of the input device 110 is, the higher the image resolution should be, so that an equivalent positioning accuracy to the near distance can be reached. However, due to the limitations of the processing speed and data transmission rate of the processing module, an image with a too high resolution is hard to be transmitted to the processing module with a high frame rate from the camera and rapidly processed on the processing module. For example, currently, many common cameras can only transmit a 1080P image at 30FPS and transmit a VGA image at 60FPS. If a 5M image is captured, it would be very hard to be rapidly transmitted and processed. A feasible method is to select a transmitted image and a processing area with a corresponding resolution based on the latest use state, so as to reach an optimal precision at the corresponding distance.

For example, in a default state, if the input detection system 100 is just started or has not been used for a long time, the camera 121 may first obtain low-resolution imaging information of the light-emitting source 111, e.g., a size of 1080P, and then the camera 121 or processing module 122 searches the input light spot of the light-emitting source 111 in a global-image state, i.e., within the scope of the whole imaging information. Once the input light spot is found, the camera 121 or processing module 122 may determine a to-be-detected area with the input light spot as the center based on the size of the input light spot or the distance information of the light-emitting source 111, and obtain a higher-resolution second image corresponding to the to-be-detected area. Then, the detection device 120 may obtain more accurate position coordinate of the input light spot and light spot attribute information of the input light spot such as size, light distribution feature, etc., to thereby obtain a more precise position information of the input device 110.

Moreover, in subsequent use, the detection device 120 may select a corresponding resolution and to-be-detected area for processing based on the historical use state of the input device 110 such as the latest position or distance of the input device 110, to thereby guarantee that a smaller image area is always processed and transmitted. When the detection device 120 cannot detect an input light spot, particularly when the detection device 120 determines that the light-emitting source 111 is in an on state but its input light spot cannot be detected, the detection device 120 may return to use the default state at any time to re-search the input light spot so as to determine a corresponding to-be-detected area.

Here, the selection of the to-be-transmitted area and its resolution may be performed in each frame or once every several frames, or only updated when other predetermined conditions are satisfied, for example, updating the currently adopted resolution and the to-be-detected area when the input light spot approaches to the edge of the current to-be-detected area. To select a resolution based on the size of the input light spot or the distance of the input device 110 may enable the second image obtained therefrom to cover a larger angle in a near distance while obtain a higher precision in a remote distance.

Further, a center of the to-be-detected area may be the latest inputted position of the gravity center or the central position obtained through weighted calculation. As shown in FIG. 12, the size of the to-be-detected area 00 and its resolution may be calculated based on the following equation:

$$S = \frac{2 * W * N}{tan ( \frac{δ}{2} ) * Z}$$

wherein W denotes a reserved space radius (e.g., 1.5 m) for input operation, N denotes the resolution (e.g., 2048 pixels) of the camera in that direction, δ denotes lens elevation angle of the camera (e.g., 70°), Z denotes the current input distance, i.e., the distance of the light-emitting source 111 with respect to the camera 121. Therefore, the required image pixel number S, i.e., the length of the to-be-detected area 00, in the case of satisfying the reserved space condition, may be calculated. Of course, if it is calculated that S>N, then S=N, i.e., the length of the to-be-detected area cannot exceed the size of the original image.

The maximum area length for actual transmission or processing is denoted as S_{M}. If S_{M}<S, then the image area needs to be scaled down at a scaling coefficient of F=S_{M}/S. In other words, the resolution of the original image will not be used at this point. A typical S_{M} may be 1024 or 800, etc. Further, the image scaling coefficient provided by the camera OEM can only be several preset levels, e.g., ½, ¼, etc. In this case, a scaling coefficient level closest to satisfying the condition may be selected.

It should be noted that those skilled in the art should understand the above manner of determining a to-be-detected area and its resolution is only exemplary, which should be regarded as any limitation to the present invention, and other existing or future developed manners of determining a to-be-detected area and its resolution, if applicable to the present invention, should fall into the protection scope of the present invention.

Besides, since it takes certain time for the camera 121 to update the to-be-detected area, the times of update operations should be reduced as possible when determining the to-be-detected area.

A preferred approach may be determining the to-be-detected area corresponding to the input light spot by merely performing a global-image search to the first frame imaging information of the light-emitting source 111, while for the subsequent imaging information of the light-emitting source 111, the to-be-detected area in the current imaging information may be predicted based on the coordinate information of the input light spot in the imaging information of the previous frame.

For example, in step S301, the camera 122 shoots to obtain a low-resolution image of the light-emitting source 111; the detection device 120 determines a to-be-detected area corresponding to a input light spot in the current low-resolution image based on the coordinate information of the input light spot in the previous frame(s) of imaging information of the light-emitting source 111 in combination with the motion feature information of the light-emitting source 111, and provides a high-resolution image corresponding to the to-be-detected area as imaging information of the light-emitting source 111 to the detection device 120, such that the detection device 120 may further detect in the imaging information the input light spot of the light-emitting source.

Here, the detection device 120 may appropriately adjust the center of the to-be-detected area based on the motion trends of prior frames in the plurality of pieces of imaging information of the light-emitting source 111. For example, based on the motion of the input light spot in the imaging information of a plurality of prior frames of the light-emitting source 111, it is predicted that the input light spot of the light-emitting source 111 will appear in the next frame imaging information near a position with respect to the current position offset (dₓ, d_{y}), and at this point, if updating the to-be-detected area is triggered, for example, by the input light spot arrives at the edge of the to-be-detected area, updating the to-be-detected area may be performed with the predicted position as the center, instead of using the current position as the center.

Besides, the motion feature information of the light-emitting source 111 is such as the motion speed of the light-emitting source 111 and the motion trend of the light-emitting source 111, etc.,. When the light-emitting source 111 moves at a low speed, the to-be-detected area may be scaled down appropriately so as to improve the transmission and processing speed of the image; on the contrary, when the light-emitting source 111 moves at a high speed, the to-be-detected area may be scaled up appropriately based on the speed so as to adapt to the possible motion scope of the light-emitting source 111, to thereby reduce the times of updating the to-be-detected area during a high-speed motion.

FIG. 4 is a flowchart of a method according to one embodiment of the present invention, which illustrates a process of detecting three-dimensional position information of an input device, wherein the input device 110 comprises a light-emitting source 111, and the detection device 120 externally connected to a camera 122.

With reference to FIGS. 1 and 4, in step S401, the camera 122 captures imaging information of the light-emitting source 111; in step S402, the detection device 120 detects an input light spot of the light-emitting source 111 based on the imaging information; in step S403, the detection device 120 obtains three-dimensional position information of the light-emitting source 111 based on light spot attribute information of the input light spot by means of a predetermined fitting curve.

For example, in step S401, the camera 122 captures imaging information of the light-emitting source 111; in step S402, the detection device 120 detects the imaging information based on the shape, radius, and the like of the light spot, for example, determining an input light spot whose shape is round and whose radius falls within the predetermined valid radius scope as the input light spot of the light-emitting source 111; in step S403, the detection device 120 obtains an included angle θ between an axial line of the light-emitting source 111 and the connection line from the light-emitting source 111 to the camera 122 based on the light spot radius r and brightness I of the input light spot of the light-emitting source 111 in accordance with a predetermined included angle fitting curve θ=h(r, I), the included angle θ being the three-dimensional rotational position information.

Here, for determining the included angle fitting curve, corresponding r and I may be detected for the included angle θ; for example, collecting enough samples under different included angles θ between a certain step length, i.e., the values of r and I (or other available light spot attributes); fitting the mapping relationship between r, I and θ using a linear, quadratic or more-degree curve based on the minimum error criterion. During sampling, within a valid working scope, an LED light source with an optical feature that the included angle θ may uniquely be determined by the combination of r and I, should be selected.

Besides, the fitting curve of the included angle θ further may be determined in combination with the light distribution characteristic of the input light spot and/or the light emitting mode of the light-emitting source 111. Herein the light distribution characteristic of the input light spot includes for example, the principal axis direction and size of the characteristic transformation (PCT transformation) of light distribution within the input light spot. The light emitting mode may be a special light emitting mode added to the LED light source through a special technique, such as the center of the LED light source does not emit light (the corresponding input light spot is a central black spot), the center of the LED light source emits white light (the corresponding input light spot is central bright spot), or the LED light source emits light of different colors (frequencies), or that enables the input light spot of the LED light source as captured by the camera to present an oval shape, not a common round shape, etc., such light emitting modes may help to detect the three-dimensional position information of the light-emitting source 111.

For example, the self-rotating angle γ of the LED light source may be obtained through detecting the direction of the oval, and the direction of the oval is the principal axis direction of the characteristic transformation of the oval distribution. Through detecting the central black spot or bright spot of the input light spot, the deflection direction and size of the included angle θ may be detected, wherein the black spot or bright spot is the darkest or brightest central position in the light spot. The deflection direction of the included angle θ is the direction from the center of the input light spot to the black spot or bright spot center. Detecting the deflection directions and sizes of included angles θ, the distance d from the corresponding light spot center to the black spot or bright spot center, and the gradient magnitude k of the brightness variation of the input light spot in the deflection direction; θ=h(d, k). Since k might also be related to the distance information Z, thereby θ=h(d, k, Z); or in more complex scenario, θ=h(d, k, X, Y, Z); correspondingly, at this point, it is required to collect enough samples for different X, Y, Z under different θ between a certain step length, i.e., the values of d and k.

Preferably, the three-dimensional position information of the input device 110 includes the three-dimensional translational position information of the input device 110, and the predetermined fitting curve includes a predetermined distance fitting curve; in step S403, the detection device 120 determines distance information of the input device with respect to the camera 121 based on the light spot attribute information of the input light spot in accordance with the predetermined distance fitting curve, and obtains the three-dimensional translational position information of the input device 110 based on the distance information and the two-dimensional coordinate of the input light spot in the imaging information.

For example, after determining the input light spot of the light-emitting source 111, in step S403, the detection device 120 determines the distance Z of the light-emitting source 111 with respect to the camera 121 based on the light spot radius r and brightness I of the input light spot in accordance with the predetermined distance fitting curve Z=f(1/r, I), and in combination with the two-dimensional coordinate (x, y) of the circle center of the input light spot in the shot image, calculates to obtain the three-dimensional translational position information (X, Y, Z) of the light-emitting source 111 through the equations X=x(λ−Z)/λ, Y=y(λ−Z)/λ, wherein the three-dimensional translational position information is also the three-dimensional translational position information of the input device 110 at the same time.

Here, for the determination of the distance fitting curve, corresponding r and I for distance Z may be measured. For example, for different distances Z, enough samples are measured according to a certain step length, i.e., values of r and I (or other available light spot attributes); fitting the mapping relationship between r, I and Z using a linear, quadratic or more-degree curve based on the minimum error criterion. During sampling, within a valid working scope, an LED light source with a optical feature that the distances Z may uniquely be determined by the combination of r and I, should be selected

For simplifying the operation, when sampling, enough samples may be measured for different distances Z under different included angles θ between a certain step length, i.e., values of r and I, and the fitting curves of the distance Z and included angle θ are correspondingly determined respectively.

Besides, the fitting curve of the distance Z further may be determined in combination with the light distribution characteristic of the input light spot and/or the light emitting mode of the light-emitting source 111. Herein the light distribution characteristic of the input light spot includes for example, the principal axis direction and size of the characteristic transformation (PCT transformation) of light distribution within the input light spot. The light emitting mode may be a special light emitting mode added to the LED light source through a special technique, such as the center of the LED light source does not emit light (the corresponding input light spot is a central black spot), the center of the LED light source emits white light (the corresponding input light spot is central bright spot), or the LED light source emits light of different colors (frequencies), or that enables the input light spot of the LED light source as captured by the camera to present an oval shape, not a common round shape, etc., such light emitting modes may help to detect the three-dimensional position information of the light-emitting source 111.

For example, Z=g(r, I, t1, t2), wherein t1, t2 denote variants of light distribution feature within the input light spot. Since there are more variants reflecting the three-dimensional position information, this method has a more widely applicable LED light source and is more accurate in detecting the three-dimensional position information of the LED light source.

FIG. 5 is a flowchart of a method according to another embodiment of the present invention, showing a process for detecting three-dimensional position information of an input device, wherein the input device 110 comprises a light-emitting source 111, and the detection device 120 is externally connected to a camera 122.

With reference to FIGS. 1 and 5, in step S501, the camera 122 captures imaging information of the light-emitting source 111; in step S502, the detection device 120 detects an input light spot of the light-emitting source 111 based on the imaging information; in step S503, the detection device 120 obtains three-dimensional position information of the light-emitting source 111 based on light spot attribute information of the input light spot by means of looking up a predetermined light spot attribute sample table.

For example, in step S501, the camera 122 shoots an image of the light-emitting source 111; in step S502, the detection device 120 detects brightness of each round light spot in the image and uses a round light spot with greatest brightness value as the input light spot of the light-emitting source 111; in step S503, the detection device 120 obtains an included angle θ of the light-emitting source 111 based on radius r and brightness I of the input light spot through looking up a predetermined light spot attribute sample table.

Here, enough sample values of r, I, and θ are collected and stored according to a certain angle interval so as to build a light spot attribute-included angle sample table. For a group of to-be-queries r and I, when the sample table does not include the corresponding records yet, one or more groups of r and I samples with a distance nearest to the to-be-queried r and I in the sample may be calculated, and the included angle θ of the light-emitting source 111 may be obtained through calculating one or more θ samples corresponding thereto according to a sample interpolation algorithm, wherein the sample interpolation algorithm includes, but not limited to, nearest neighborhood interpolation, bilinear weighted interpolation, and bicubic interpolation, and any other existing or possibly evolved interpolation algorithm in the future which is applicable for the present invention.

For other light spot attribute information of the input light spot, such as light distribution characteristics of the input light spot or other attributes corresponding to the light emitting mode of the light-emitting source 111, a corresponding light spot attribute-included angle sample table may be sampled and built according to the above method, so as to be available for subsequently directly looking up the sample table to obtain the included angle θ, or to calculate and obtain the included angle θ based on the sample table through the sample interpolation algorithm.

Preferably, the three-dimensional position information of the input device 110 comprises three-dimensional translational position information of the input device 110, and the predetermined light spot attribute sample table includes a predetermined light spot attribute-distance sample table; in step S503, the detection device 120 determines distance information of the input device 110 with respect to the camera 121 based on the light spot attribute information of the input light spot in accordance with the predetermined light spot attribute-distance sample table, and obtains the three-dimensional translational position information of the input device 110 based on the distance information and the two-dimensional coordinate of the input light spot in the imaging information.

For example, after the detection device 120 detects and obtains the input light spot of the light-emitting source 111, in step S503, the detection device 120 obtains distance Z of the light-emitting source 111 with respect to the camera 121 based on the radius r and brightness I of the input light spot through looking up the predetermined light spot attribute sample table, and calculates to obtain the three-dimensional translational position information of the light-emitting source 111 with reference to the two-dimensional coordinate of the circle center of the input light spot in its imaging information.

Here, enough sample values of r, I, and Z are collected and stored according to a certain distance interval so as to build a light spot attribute-distance sample table. For a group of to-be-queried r and I, when the sample table does not include corresponding records yet, one or more group of r and I samples with a distance nearest to the to-be-queried r and I in the sample table may be calculated, and the distance Z of the light-emitting source 111 with respect to the camera 121 is obtained through calculating one or more Z samples corresponding thereto according to the sample interpolation algorithm, wherein the sample interpolation algorithm includes, but not limited to, nearest neighborhood interpolation, bilinear weighted interpolation, and bicubic interpolation, and any other existing or possibly evolved interpolation algorithm in the future which is applicable for the present invention.

For other light spot attribute information of the input light spot, such as light distribution characteristics of the input light spot or other attributes corresponding to the light emitting mode of the light-emitting source 111, a corresponding light spot attribute-distance sample table may be sampled and built according to the above method, so as to be available for subsequently directly looking up the sample table to obtain the distance Z, or to calculate and obtain the distance Z based on the sample table through the sample interpolation algorithm.

Preferably, with reference to FIGS. 1-5, in one preferred embodiment of the present invention, the camera 122 shoots a plurality of frames of images of the light-emitting source 111; the detection device 120 detects the input light spot of the light-emitting source 111 in each frame of image based on the plurality of frames of images; subsequently, the detection device 120 obtains the three-dimensional position information of the input device 110 based on the light spot attribute information of the input light spot in accordance with a predetermined mapping relationship and a multi-frame averaging algorithm.

Here, the detection device 120 obtains the three-dimensional position information of the input device 110 in the following manners, but not limited thereto:

1) obtaining average light spot attribute information based on the light attribute information of the input light spot in each frame of image through the multi-frame averaging algorithm, and obtaining the three-dimensional position information of the input device 110 based on the average light spot attribute information in accordance with the predetermined mapping relationship.

For example, with the current frame by reference, the brightness and circle radius of the input light spot of each frame in the previous 5 frames of images are queried, and in combination with brightness and circle radius of the input light spot of the current frame, the brightness and circle radius of the input light spots in the 6 frames of images are averaged through an arithmetic averaging algorithm, and, the three-dimensional position information of the input device 110 corresponding to the current frame is obtained based on the average brightness and average circle radius by means of the aforementioned fitting curve or light spot attribute sample table.

2) obtaining reference three-dimensional position information of the input device 110 corresponding to each frame based on the light spot attribute information of the input light spot in each frame of image according to a predetermined mapping relationship; obtaining three-dimensional position information of input device 110 based on the reference three-dimensional position information by means of the multi-frame averaging algorithm.

For example, with the current frame by reference, three-dimensional position information of the input device 110 corresponding to each frame in previous 5 frames of images are queried, and through a weighted averaging algorithm, for example, a frame nearer to the current frame in distance has a higher weight, an average value of the reference three-dimensional position information of the light-emitting source 111 corresponding to the 6 frames of images is calculated, and the average value is used as the three-dimensional position information of the input device corresponding to the current frame.

Here, the multi-frame averaging algorithm includes, but not limited to, any averaging algorithm applicable for the present invention and that is similar to a low pass filtering algorithm such as Gaussian distribution-based averaging algorithm, arithmetic averaging algorithm, weighted averaging algorithm.

Those skilled in the art should understand that the above manners of obtaining three-dimensional position information of the light-emitting source and the multi-frame averaging algorithm are only examples, and other existing or possibly evolved manners of obtaining three-dimensional position information of the light-emitting source or multi-frame averaging algorithm in the future, if applicable for the present invention, should also be included within the protection scope of the present invention and incorporated hereby by reference.

FIG. 6 is a flowchart of a method according to further embodiment of the present invention, showing a process of detecting three-dimensional position information of an input device, wherein the input device 110 comprises a light-emitting source 111, and the detection device 120 is externally connected to a camera 122.

With reference to FIGS. 1 and 6, in step S601, the camera 122 captures imaging information of the light-emitting source; in step S6021, the detection device 120 obtains a plurality of candidate light spots based on the imaging information; in step S6022, the detection device 120 determines an input light spot of the light-emitting source 111 from the plurality of candidate light spots based on a light emitting mode of the light-emitting source 111; in step S603, the detection device 120 obtains three-dimensional position information of the input device 110 based on light spot attribute information of the input light spot by means of a predetermined mapping relationship.

For example, in step S601, the camera 122 shoots an image of the light-emitting source 111; in step S6021, the detection device 120 detects a plurality of candidate light spots in the image, as illustrated in FIG. 7; in step S6022, the detection device 120 determines an input light spot of the light-emitting source 111 from the candidate light spots according to a light emitting mode of the light-emitting source 111, for example, selecting a round light spot from the candidate light spots as the input light spot, and when there are still a plurality of round candidate light spots, the input light spot may be further selected with reference to the light spot radius and/or brightness, for example, only selecting a candidate light spot whose radius falls within a predetermined valid radius scope as the input light spot, or only selecting a candidate light spot with the greatest brightness value as the input light spot; in step S603, the detection device 120 obtains three-dimensional position information of the light-emitting source 111 based on the light spot attribute information of the input light spot in accordance with a predetermined mapping relationship.

Herein, the light spot attribute information of the input light spot corresponding to the light emitting mode of the light-emitting source 111 includes, but not limited to, at least any one of the following items:

1) the shape of the light spot, e.g., round, oval;
2) the color of the input light spot for example, obtaining the color of the input light spot by processing the imaging information with various kinds of color spaces such as RGB, HSV, etc.;
3) the size of the input light spot, for example, the circle radius falls within a predetermined valid radius range;
4) the brightness value of the input light spot, for example, the brightness value is greater than the brightness value of other light spot;
5) the dimming distribution pattern, for example, when the light emitting mode of the light-emitting source 111 is that the center emits a white light, then the center of the corresponding input light spot is a bright spot.
6) the color distribution pattern, e.g., belonging to a loop structure. For example, when using a color camera, the light spot imaging of a color LED on a color camera will generate different color distribution patterns at different distances, and candidate light spots may be filtered by detecting a match degree between the distance information of the color LED as determined in the previous frame imaging information and its color distribution pattern in the current imaging information, so as to enhance the noise-cancellation credibility.

When the input device 110 is in a remote distance, the imaging of the color LED will generally present a common colorful round speckle with a relatively small radius; when the input device 110 is in a near distance, the imaging will generally present a light spot structure with an over-exposure white speckle at the center and a colorful loop halo at the outer periphery and the round spot has a relatively large radius then, because the color LED is over exposed on the color camera.

The detection device 120, after finding a plurality of candidate light spots, analyzes whether the color distribution pattern of each candidate light spot conforms to a loop structure, i.e., the white round light speckle at the center is connected to the loop colorful area at the outer periphery and the colorful color should be consistent with the LED color. Preferably, the detection device 20 may also detect the size of a candidate light spot so as to determine whether the color distribution pattern of the candidate light spot matches its size information. As shown in FIG. 13, during the process of analyzing the color distribution of a candidate light spot, a round with the center of the candidate light spot as the center and R-D as the radius divides the LED light speckle, i.e., the candidate light spot, into two to-be-detected connected areas, i.e., connected area 1 (the colorful loop) and connected area 2 (the overexposed white speckle), wherein R denotes the radius of the candidate light spot, d denotes the empirical threshold of the thickness of the colorful loop, and d<R and R-d denotes the radius of the overexposed white speckle. By counting the colors in the connected area 1 and connected area 2 and the color discrepancy degree between the two areas, the LED light speckle may be divided into a common color speckle and a looped speckle with overexposed white speckle at the center. Therefore, the size of the LED light speckle may be further detected, and when a larger light speckle with a looped structure is detected, or a relatively small light speckle with a common color light speckle feature is detected, they may act as eligible colorful input light spot. When a relatively large light speckle with a common color light speckle feature is detected, or a relatively small light speckle with a loop light speckle feature is detected, they may be regarded as noise to be deleted.

Here, those skilled in the art should understand that the above filtering conditions may not only be used independently for filtering to obtain an input light spot, but also may be combined together to filter to obtain an input light spot.

Those skilled in the art should further understand that the above filtering conditions are merely exemplary for conveniently explaining the present invention, which should not be understood as any limitation to the present invention; other existing filtering conditions or those potentially evolved in the future, if applicable for the present invention, should also be included within the protection scope of the present invention.

FIG. 8 shows a flowchart of a method according to still further embodiment of the present invention, which shows a process of detecting three-dimensional position information of the detection device, wherein the input device 110 comprises a plurality of light-emitting source 111, and the detection device 120 is externally connected to a camera 122. Herein, the plurality of LED light sources may have multiple arrangement patterns: FIG. 9 illustrates an arrangement pattern for 4 LED light-emitting sources; FIG. 10 illustrates an arrangement pattern for 3 LED light-emitting sources; and FIG. 11 illustrates an arrangement pattern for 2 LED light-emitting sources.

In the present invention, for a scenario in which there are a plurality of light-emitting sources 111, each light-emitting source 111 may be configured in a different manner, such that the detection device 120 may effectively identify the input light spot corresponding to each light-emitting source 111 according to the configuration manners of each light-emitting source 111, e.g., optical features, light emitting modes, etc., to thereby further calculate the three-dimensional position information of each light-emitting source 111. For example, a plurality of light-emitting sources 111 are disposed according to a certain distance and included angle, and different optical features or light emitting modes may be set for each light-emitting source 111, e.g., emitting light of different color, frequency, or brightness, and introducing a light reflecting material or light transparent material to change the shape of the input light spot, so as to calculate and obtain the three-dimensional position information of the input device 110 based on the geometric structure between the plurality of light-emitting sources 111. Moreover, because the configuration manner of each light-emitting source 111 is different, the detection device 120 may collect more light spot attribute information of the input light spot so as to enrich the light spot attribute sample table and obtain a more accurate fitting curve. For example, each light-emitting source 111 adopts a different brightness, e.g., I₁, I₂, and I₃, then the fitting curve for an included angle of the input device 110 is θ=h(r₁, r₂, r₃, I₁, I₂, I₃), or the distance fitting curve of the input device 110 is Z=f(1/r₁, 1/r₂, 1/r₃, I₁, I₂, I₃).

Further, in the present invention, in the case of the input device comprising a plurality of light-emitting sources 111, the three-dimensional position information of the input device 110 may either be determined based on three-dimensional position information of one of the light-emitting sources 111, or be determined based on three-dimensional position information of part or all of the light-emitting sources 111. In the below, with reference to FIG. 8 to describe a preferred embodiment of the present invention, it determines the three-dimensional position information of the input device 110 based on three-dimensional position information of part or all of the light-emitting sources 111 comprised in the input device 110.

As illustrated in FIG. 8, in step S801, the camera 122 captures imaging information of a plurality of light-emitting sources 111; in step S8021, the detection device 120 obtains an input light spot group corresponding to the plurality of light-emitting sources 111 based on the imaging information, wherein each input light spot in the input light spot group corresponds to one of the plurality of light-emitting sources 111; in step S8022, the detection device 120 detects one or more input light spots in the input light spot group so as to be used to obtain three-dimensional position information of one or more of the plurality of light-emitting source 111; in step S8031, the detection device 120 obtains the three-dimensional position information of the one or more of the plurality of light-emitting sources 111 based on the light spot attribute information of the one or more input light spots by means of a predetermined mapping relationship; in step S8032, the detection device 120 determines the three-dimensional position information of the input device 110 based on the three-dimensional position information of the one or more of the plurality of light-emitting sources 111.

Here, the three-dimensional position information of the input device 110 at least may be determined from the following two dimensions:

1) first determining the input light spot(s) for calculation in the group of input light spots, and then determining the three-dimensional position information of the input device 110 based on the three-dimensional position information of the light-emitting source 111 corresponding to the input light spot(s).

For example, in step S801, the camera 122 captures imaging information of all light-emitting sources 111; in step S8021, the detection device 120 obtains an input light spot group corresponding to all the light-emitting sources 111 based on the imaging information, wherein each input light spot in the input light spot group corresponds to one light-emitting source 111; in step S8022, the detection device 120 selects some input light spots from the input light spot group based on for example light spot attribute information of the input light spots, geometrical structure between the light-emitting sources 111, so as to be used to obtain the three-dimensional position information of the light-emitting sources 111 corresponding to the some input light spots; in step S8031, the detection device 120 obtains the three-dimensional position information of the some light-emitting sources 111 corresponding to the some input light spots based on the light spot attribute information of the some input light spots in accordance with a predetermined mapping relationship; in step S8032, the detection device 120 averages the three-dimensional position information of the some light-emitting sources 111 to obtain the three-dimensional position information of the input device 110.

2) first obtaining the three-dimensional position information of each input light spot in the group of input light spots, and then determining the three-dimensional position information of the input device 110 by means of various calculation processing on the three-dimensional position information.

For example, in step S801, the camera 122 captures imaging information of all light-emitting sources 111; in step S8021, the detection device 120 obtains an input light spot group corresponding to all the light-emitting sources 111 based on the imaging information, wherein each input light spot in the input light spot group corresponds to one light-emitting source 111; in step S8022, the detection device 120 obtains each input light spot in the input light spot group so as to be used to obtain the three-dimensional position information of the light-emitting source 111 corresponding to each input light spot; in step S8031, the detection device 120 obtains the three-dimensional position information of each light-emitting source 111 based on the light spot attribute information of each input light spot in accordance with a predetermined mapping relationship; in step S8032, the detection device 120 calculates three-dimensional position information of a gravity center of a geometry constructed by all the light-emitting sources 111 based on the geometrical structure between the light-emitting sources 111 in accordance with the three-dimensional position information of each light-emitting source 111, and uses the three-dimensional position information of the gravity center as the three-dimensional position information of the input device 110.

Taking FIG. 10 as an example, 3 LED light sources LED1, LED2, and LED3 are placed in accordance with an equilateral triangle, with the side length of the equilateral triangle being denoted as L, the coordinate of the gravity center being denoted as (X_{g}, Y_{g}, Z_{g}), and the three-dimensional rotational position information being denoted as (α,β,γ). The circle center coordinates of the input light spots of LED1, LED2, and LED3 in their image are denoted as (x₁,y₁), (x₂,y₂), and (x₃,y₃), respectively, and in accordance with equations Z=f(1/r, I), and X=x (λ−Z)/λ, Y=y(λ−Z)/λ, the three-dimensional translational position information (X₁, Y₁, Z₁) of LED1, LED2, and LED3 are calculated and obtained, respectively. The self-rotating angle γ of the equilateral triangle is calculated based on the angle variation of the connection line between the gravity center of the equilateral triangle in the imaging of LED1, LED2 and LED3 and the LED1, and through the equations

$${X}_{1} = {X}_{g} + \frac{\sqrt{3}}{3} L ( cos γcos β ) , {Y}_{1} = {Y}_{g} + \frac{\sqrt{3}}{3} L ( cos γcos α ) , \\ {Z}_{1} = {Z}_{g} + \frac{\sqrt{3}}{3} L ( cos αcos β ) , \\$$

X_{g}, U_{g}, Z_{g}, and α, β may be calculated to obtain, thereby obtaining the three-dimensional translational position information (Xg, Yg, Zg) of the gravity center of the equilateral triangle, and the three-dimensional rotational position information (α, β, γ) of the gravity center of the equilateral triangle.

It should be noted that the present invention may be implemented in software or a combination of software and hardware; for example, it may be implemented by an ASIC (Application Specific Integrated Circuit), a general-purpose computer, or any other similar hardware devices.

The software program of the present invention may be executed by a processor to implement the above steps or functions. Likewise, the software program of the present invention (including relevant data structure) may be stored in a computer readable recording medium, for example, a RAM memory, a magnetic or optical driver, or a floppy disk, and other similar devices. Besides, some steps or functions of the present invention may be implemented by hardware, for example, a circuit cooperating with a processor to execute various functions or steps.

Additionally, a portion of the present invention may be applied as a computer program product, for example, a computer program instruction, which, may invoke or provide a method and/or technical solution according to the present invention through operations of the computer when executed by the computer. Further, the program instruction invoking the method of the present invention may be stored in a fixed or mobile recording medium, and/or transmitted through broadcast or data flow in other signal bearer media, and/or stored in a working memory of a computer device which operates based on the program instruction. Here, one embodiment according to the present invention comprises an apparatus comprising a memory for storing a computer program instruction and a processor for executing the program instruction, wherein when the computer program instruction is executed by the processor, the apparatus is triggered to run the methods and/or technical solutions according to a plurality of embodiments of the present invention.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims instead of the above description, and all variations intended to fall into the meaning and scope of equivalent elements of the claims should be covered within the present invention. No reference signs in the claims should be regarded as limiting of the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. A method of detecting three-dimensional position information of an input device, wherein the input device comprises at least one light-emitting source;
wherein the method comprises steps of:
a. capturing by a camera imaging information of the light-emitting source;
b. detecting input light spot of the light-emitting source based on the imaging information;
c. obtaining three-dimensional position information of the input device based on light spot attribute information of the input light spot by means of a predetermined mapping relationship.

2. The method according to claim 1, wherein the three-dimensional position information comprises three-dimensional rotational position information of the input device.

3. The method according to claim 1 or 2, wherein the step c comprises:
obtaining the three-dimensional position information of the input device based on the light spot attribute information of the input light spot by mean of a predetermined fitting curve.

4. The method according to claim 3, wherein the three-dimensional position information of the input device comprises three-dimensional translational position information of the input device and the predetermined fitting curve comprises a predetermined distance fitting curve;
wherein the step c comprises:
determining distance information of the input device with respect to the camera based on the light spot attribute information of the input light spot by mean of the predetermined distance fitting curve;
obtaining the three-dimensional translational position information of the input device based on the distance information and two-dimension coordinate of the input light spot in the imaging information.

5. The method according to claim 1 or 2, wherein the step c comprises:
obtaining the three-dimensional position information of the input device based on the light spot attribute information of the input light spot by means of looking up a predetermined light spot attribute sample table.

6. The method according to claim 5, wherein the step c comprises:
obtaining the three-dimensional position information of the input device based on the light spot attribute information of the input light spot by means of looking up the predetermined light spot attribute sample table and a sample interpolation algorithm.

7. The method according to claim 5, wherein the three-dimensional position information of the input device comprises three-dimensional translational position information of the input device, and the predetermined light spot attribute sample table comprises a predetermined light spot attribute-distance sample table;
wherein the step c comprises:
c1 determining distance information of the input device with respect to the camera based on the light spot attribute information of the input light spot by means of the predetermined light spot attribute-distance sample table;
obtaining the three-dimensional translational position information of the input device based on the distance information and two-dimensional coordinate of the input light spot in the imaging information.

8. The method according to claim 7, wherein the step c1 comprises:
determining the distance information based on the light spot attribute information of the input light spot by means of the predetermined light spot attribute-distance sample table and the sample interpolation algorithm.

9. The method according to claim 1, wherein the imaging information comprises a plurality of frames of images of the light-emitting source;
wherein the step c comprises:
obtaining the three-dimensional position information of the input device based on the light spot attribute information of the input light spot by means of the predetermined mapping relationship and a multi-frame averaging algorithm.

10. The method according to claim 9, wherein the step c comprises:
obtaining average light spot attribute information based on the light spot attribute information of the input light spot in each of the plurality of frames of images by means of the multi-frame averaging algorithm; and obtaining the three-dimensional position information of the input device based on the average light spot attribute information by means of the predetermined mapping relationship.

11. The method according to claim 9, wherein step c comprises:
obtaining reference three-dimensional position information of the input device corresponding to each of the plurality of frames of images based on the light spot attribute information of the input light spot in each of the plurality of frames of images by means of the predetermined mapping relationship;
obtaining the three-dimensional position information of the input device based on the reference three-dimensional position information by means of the multi-frame averaging algorithm.

12. The method according to claim 1, wherein the imaging information comprises at least two images of the light-emitting source in the same time, wherein each of the at least two images belongs to a different resolution level;
wherein the step b comprises:
obtaining a candidate area corresponding to the input light spot based on the image of a relatively lower resolution level in the at least two images;
obtaining the input light spot based on the candidate area of a higher resolution level in the at least two images.

13. The method according to claim 1, wherein the step a comprises:
capturing by the camera to obtain a high-resolution image of the light-emitting source;
searching the input light spot in a low-resolution image obtained from the high-resolution image, to determine a to-be-detected area and a resolution thereof for further detecting the input light spot, the resolution of the to-be-detected area being higher than the resolution of the low-resolution image;
obtaining a second image corresponding to the to-be-detected area and the resolution thereof, and using the second image as the imaging information for the input light source.

14. The method according to claim 13, wherein the to-be-detected area and the resolution thereof are determined based on at least one of the following information:
the size of the input light spot;
the distance of the input device;
the historical use state of the input device.

15. The method according to claim 1, wherein the step a comprises:
capturing by the camera to obtain a low-resolution image of the light-emitting source;
determining a to-be-detected area of the input light spot from the low-resolution image based on imaging information of prior frame(s) of the light-emitting source in combination with motion feature information of the input device;
using a high-resolution image corresponding to the to-be-detected area as the imaging information for the input light source.

16. The method according to claim 1, wherein the step b comprises:
obtaining a plurality of candidate light spots based on the imaging information;
filtering to determine the input light spot from the plurality of candidate light spots based on a light emitting mode of the light-emitting source.

17. The method according to claim 16, wherein the light spot attribute information of the input light spot corresponding to the light emitting mode of the light-emitting source comprises color distribution pattern of the light spot and size of the light spot;
wherein, the filtering operation in the step b comprises:
determining the candidate light spot as the input light spot when the color distribution pattern of the candidate light spot is of a looped structure, and the color distribution pattern of the candidate light spot matches the size thereof.

18. The method according to claim 1, wherein the input device comprises a plurality of light-emitting sources;
wherein the step b comprises:
obtaining an input light spot group corresponding to the plurality of light-emitting sources based on the imaging information, wherein each input light spot in the input light spot group corresponds to one of the plurality of light-emitting sources;
detecting one or more input light spots in the input light spot group so as to be used for obtaining three-dimensional position information of one or more of the plurality of light-emitting sources;
wherein the step c further comprises:
obtaining the three-dimensional position information of the one or more of the plurality of light-emitting sources based on the light spot attribute information of the one or more input light spots by means of the predetermined mapping relationship;
determining the three-dimensional position information of the input device based on the three-dimensional position information of the one or more of the plurality of light-emitting sources.

19. The method according to claim 18, wherein the plurality of light-emitting sources are configured according to predetermined rule(s), the predetermined rule(s) comprises at least one of the following items:
configuring the plurality of light-emitting sources according to different optical features;
configuring the plurality of light-emitting sources according to different light emitting modes;
configuring the plurality of light-emitting sources according to a predetermined geometrical structure.

20. A system of detecting three-dimensional position information for an input device, wherein the system comprises an input device and a detection device, the input device comprising at least one light-emitting source, the detection device comprising a camera and at least one processing module;
the camera being for capturing imaging information of the light-emitting source;
wherein the processing module is configured to:
detect an input light spot of the light-emitting source based on the imaging information;
obtain three-dimensional position information of the input device based on light spot attribute information of the input light spot by means of a predetermined mapping relationship.

21. The system according to claim 20, wherein the input device comprises a plurality of light-emitting sources;
wherein the operation of detecting input light spots of the light-emitting sources comprises:
obtaining an input light spot group corresponding to the plurality of light-emitting sources based on the imaging information, wherein each input light spot in the input light spot group corresponds to one of the plurality of light-emitting sources;
detecting one or more input light spots in the input light spot group so as to be used for obtaining three-dimensional position information of one or more of the plurality of light-emitting sources;
wherein the processing module is further configured to:
determine the three-dimensional position information of the input device based on the three-dimensional position information of the one or more of the plurality of light-emitting sources.
